(19) United States
(12) Patent Application Publication
(10) Pub. No.: US 2026/0195111 A1
(43) Pub. Date: Jul. 9, 2026

(54) HYPERAUTOMATION OF APPLICATION DEPLOYMENT WITH INFRASTRUCTURE AS CODE

(71) Applicant: Bank of America Corporation, Charlotte, NC (US)

(72) Inventors: Ganesh Balasubramanian, Chennai (IN); Preetha Dhanasekaran, Chennai (IN); Senthil Kumar Panneerselvam, Levittown, PA (US)

(21) Appl. No.: 19/010,463

(22) Filed: Jan. 6, 2025

(51) Int. Cl. G06F 8/60; G06F 8/71; G06F 21/57

(52) U.S. Cl. CPC G06F 8/60; G06F 8/71; G06F 21/57

(57) ABSTRACT

A hyper-automated system and method for integrated application and infrastructure deployment, unifying traditionally separate workflows, is disclosed. Using infrastructure as code (IaC), a central release orchestrator manages multiple components, including a build orchestrator, artifact repository, IaC platform, and application deployment module. The build orchestrator validates IaC scripts, which are then stored in an artifact repository, while the release orchestrator provisions infrastructure resources in cloud or on-premises environments. A configuration management database tracks infrastructure states for auditability, and a tech stack deployment module installs essential software dependencies. The system dynamically scales resources based on real-time demand, with a security module enforcing authorization protocols. Centralized monitoring and reporting modules provide comprehensive visibility into deployment metrics and trends, supporting compliance and optimization. This unified deployment framework reduces manual intervention, accelerates deployment cycles, and enhances reliability and security across multiple environments.

### TECHNICAL FIELD

The inventions disclosed herein pertain to the field of software development, installation, and management, specifically relating to the automation and orchestration of application deployment and infrastructure provisioning processes involving technologies that facilitate the creation, configuration, and management of software applications throughout their lifecycle, from development to deployment. The invention utilizes a comprehensive workflow that integrates infrastructure as code (IaC) with application deployment processes, automating the entire lifecycle of deployment across different environments. By leveraging tools for continuous integration, testing, and deployment, the invention ensures that both the infrastructure and the application are deployed in a coordinated manner, eliminating manual intervention and reducing the risk of errors. The system incorporates release orchestration tools that manage dependencies, enforce security protocols, and ensure that deployments adhere to predefined configurations and compliance standards. Through this integration, the invention significantly enhances the efficiency and consistency of application deployment, aligning with the core objectives of the software development and management field by automating key stages of application delivery while maintaining control over security and performance.

### DESCRIPTION OF THE RELATED ART

In complex computing environments, application deployment and infrastructure management are frequently handled as separate tasks, creating significant inefficiencies and operational delays. The traditional separation between infrastructure provisioning and application deployment means that different teams must coordinate each task independently, often resulting in scheduling conflicts, miscommunications, and delays. This division complicates the work of release engineers, who must navigate multiple toolsets and workflows, each with unique configurations and dependencies. The process is particularly burdensome in large enterprises where compliance requirements dictate that numerous steps must be executed in a specific order, requiring rigorous approval processes for each stage. Without a unified approach, engineers often face difficulties in synchronizing application and infrastructure setups, which can delay deployments, increase costs, and ultimately slow down the time-to-market for new software updates.

In environments where multiple applications are deployed across various cloud providers, managing distinct workflows for infrastructure and applications becomes even more challenging. Cloud providers each have unique infrastructure services, such as VMs, databases, and networking setups, that require specific configurations and access controls. When infrastructure and application deployments are managed independently, organizations need to ensure that each provider's configuration is compatible with application needs, which requires extensive testing and validation. The absence of a cohesive process for both infrastructure provisioning and application deployment often forces engineers to spend time troubleshooting compatibility issues after deployments, resulting in added overhead and reduced operational efficiency. Additionally, these disparate workflows lead to duplicative efforts as engineers have to set up, configure, and manage the same environments multiple times across various stages.

Operationally, the lack of integration between infrastructure and application deployments creates gaps in visibility. Release teams often struggle to maintain a comprehensive view of their application and infrastructure statuses due to the use of distinct, non-integrated tools. This fragmentation can lead to situations where infrastructure is provisioned without the knowledge of the application team, resulting in wasted resources and potential security vulnerabilities. When application teams are unaware of changes in the infrastructure, they cannot adequately plan or optimize their applications to run efficiently, leading to higher costs, performance degradation, and unnecessary complexity in troubleshooting issues. The split in visibility also complicates auditing and compliance efforts, as both workflows are tracked separately, making it difficult to produce unified reports or verify that all steps in the deployment lifecycle have been properly executed and documented.

The absence of a streamlined workflow increases the risk of errors during deployments. When release engineers work with two isolated workflows, they must manually manage dependencies between infrastructure and application components, often leading to configuration mismatches. These mismatches are particularly problematic in environments that require precise configurations to maintain security and performance standards, such as financial services. Without synchronization, there is a higher chance of incomplete or incorrect setups, which could lead to system downtime, security breaches, or costly rollbacks. Each rollback or error necessitates additional rounds of testing and validation, further slowing down the deployment cycle and decreasing overall productivity. The increased risk of human error in these independent workflows not only compromises the quality of deployments but also adds unnecessary complexity to the troubleshooting process.

A significant challenge arises in maintaining the security and compliance of both infrastructure and application environments when handled separately. Security policies, such as access control and network configurations, are typically applied to infrastructure independently from application deployments. This separation makes it difficult to enforce end-to-end security policies consistently, leading to potential vulnerabilities. For instance, if infrastructure configurations do not align with application requirements, sensitive data may be exposed, or unauthorized access may be granted. The lack of unified security protocols across both workflows results in increased auditing efforts and compliance risks, particularly in regulated industries. Compliance teams often struggle to maintain oversight over each step in the deployment lifecycle, making it challenging to verify that all security measures have been applied consistently.

The isolated nature of infrastructure and application workflows also introduces challenges in scalability and adaptability. As organizations grow and their technological needs evolve, they require a deployment process that can easily adapt to new infrastructure types and application configurations. However, managing infrastructure and application environments separately limits the ability to quickly adjust deployments in response to changing requirements. Each adjustment requires modifications to multiple workflows, creating additional work and increasing the potential for errors. This lack of flexibility can hinder an organization's ability to respond to market changes or scale its operations efficiently, impacting competitive advantage. Engineers are often forced to develop custom scripts or use manual workarounds to handle changes, further complicating the deployment process and increasing the likelihood of system failures.

In distributed environments, where applications rely on multiple infrastructure components, the need to manage workflows independently often results in bottlenecks. Deployment pipelines become congested as different teams coordinate their work without a cohesive plan, leading to delays and idle resources. Engineers must frequently wait for infrastructure to be provisioned before they can deploy applications, causing downtime and resource wastage. Conversely, pre-provisioned infrastructure that is not yet used by applications incurs unnecessary costs. Without a unified approach, resources are allocated inefficiently, which can lead to significant expenses, especially in cloud environments where usage-based billing is common. Organizations are forced to over-provision infrastructure to prevent delays in application deployment, leading to higher operational costs.

Furthermore, the manual nature of current processes limits the potential for automation, which could alleviate many of these inefficiencies. When workflows are separated, automating both infrastructure and application deployments requires setting up distinct pipelines with individual triggers and checks. This duplication of effort not only increases the likelihood of misconfigurations but also requires additional maintenance for each pipeline. Implementing consistent automation across both workflows is nearly impossible without a unified process, leaving organizations unable to take full advantage of modern DevOps practices. This results in slower deployment cycles, lower productivity, and an increased reliance on human intervention, all of which impede the organization's ability to innovate and meet customer demands promptly.

The lack of centralized oversight complicates the process of tracking resource usage and performance metrics across infrastructure and applications. When these workflows are managed separately, release teams lack a single source of truth for monitoring deployment progress and health. This fragmentation complicates troubleshooting as teams must sift through multiple logs and dashboards to identify and resolve issues. In the event of a failure, identifying the root cause can be a time-consuming and error-prone process. A unified workflow that consolidates infrastructure and application metrics would enable faster identification of issues, reducing downtime and improving overall system resilience. However, the current setup forces teams to spend excessive time monitoring and correlating data across multiple systems, ultimately increasing operational costs and decreasing efficiency.

Current deployment processes are highly susceptible to the disruptions caused by infrastructure or application changes. When infrastructure modifications are needed—such as updating server configurations or increasing storage capacity—application teams must manually coordinate these changes with the infrastructure team to ensure compatibility. This coordination is particularly challenging in high-availability systems, where even minor delays in synchronization can lead to service interruptions. The lack of automated synchronization between infrastructure and application deployments increases the time and resources required to implement changes, which can delay critical updates and maintenance activities. The resulting delays not only affect system performance but also create challenges in adhering to service level agreements (SLAs) with customers, potentially damaging the organization's reputation.

In high-stakes environments, where data security and system reliability are paramount, the absence of an integrated deployment approach creates additional concerns. Managing separate workflows introduces the risk of security breaches, as infrastructure and application settings may be misaligned. This misalignment can create vulnerabilities, especially when configurations are manually adjusted without a clear understanding of interdependencies. Additionally, the lack of unified version control complicates the process of rolling back changes in the event of a failure. Without a centralized system to manage both infrastructure and application deployments, teams struggle to maintain consistency and traceability across deployments, exposing the organization to regulatory financial losses.

Teams that handle deployment workflows independently often struggle with a lack of resource optimization, as there is no mechanism to allocate resources dynamically based on application demand. When infrastructure and applications are managed separately, infrastructure is often over-provisioned to avoid delays, leading to wasted resources and increased costs. Conversely, under-provisioned resources can cause application performance issues, leading to user dissatisfaction. The inability to efficiently scale resources based on real-time application requirements leads to inconsistent performance and hampers the organization's ability to meet user expectations. This inefficiency is particularly detrimental in cloud environments, where dynamic resource allocation is essential to maintaining cost efficiency and high performance.

The need for approval processes in each workflow further complicates deployment timelines. Without a unified system, each workflow requires separate approval steps, which increases the administrative burden on release engineers and slows down deployment cycles. This layered approval structure makes it difficult to streamline deployment processes, as multiple teams and managers must sign off on each step independently. In highly regulated industries, where approvals are critical to ensuring compliance, this fragmented approach to approvals adds unnecessary delays. A unified approach to infrastructure and application deployment could streamline these approval processes, reducing the time and effort required to bring applications into production while maintaining compliance with regulatory standards.

The current approach to infrastructure and application deployments fails to support end-to-end visibility across the deployment lifecycle. Each workflow operates independently, making it difficult to maintain an accurate, real-time view of deployment status across both infrastructure and applications. This lack of visibility complicates coordination, as teams cannot easily track the status of resources or applications. When issues arise, teams must rely on fragmented information from multiple tools, which delays incident resolution and increases the likelihood of miscommunication. A lack of end-to-end visibility also limits the organization's ability to conduct comprehensive audits, as each workflow produces separate logs and reports that must be manually correlated.

There has long been a need for an integrated solution that addresses the inefficiencies and risks associated with managing infrastructure and application deployments separately. Organizations have struggled for years to streamline these processes while maintaining security, compliance, and cost efficiency. Despite numerous tools and approaches, none have fully resolved the challenges of synchronizing infrastructure and application workflows, creating a persistent gap in operational efficiency. This need has been especially pronounced in industries that demand high reliability and strict regulatory compliance, where manual workarounds and ad hoc integrations have been insufficient to meet deployment requirements. The lack of a unified deployment approach has created a significant and unmet demand for solutions that can reduce complexity, enhance automation, and improve visibility across the deployment lifecycle, ultimately helping organizations achieve faster and more reliable application releases.

### SUMMARY OF THE INVENTION

This invention is a sophisticated framework designed to automate and streamline the process of deploying applications and infrastructure in a cohesive and unified manner. Traditionally, deploying applications and provisioning infrastructure are handled as separate workflows, each requiring distinct tools, configurations, and teams. This separation introduces operational inefficiencies and increases the likelihood of errors, as each workflow operates independently, with little coordination between them. This invention addresses these issues by unifying the entire lifecycle, allowing both infrastructure provisioning and application deployment to be managed under a single orchestrated process. This integration enables organizations to deploy applications with infrastructure that is specifically tailored to meet application requirements, ensuring compatibility, optimizing performance, and enhancing security. By leveraging a centralized orchestrator that manages these workflows, the invention provides a controlled environment in which infrastructure and applications are deployed as one, rather than as separate, disconnected entities.

The core of this invention's functionality is built around the concept of infrastructure as code, or IaC, which allows infrastructure to be provisioned through code rather than manual processes. This approach significantly reduces setup time and minimizes human error by ensuring that infrastructure configurations are standardized and stored in version-controlled repositories. IaC enables engineers to define infrastructure requirements, such as virtual machines, network configurations, and storage, in code that can be easily modified, duplicated, and tracked over time. By storing infrastructure code in a version-controlled repository, this invention ensures that any changes made to the infrastructure can be easily tracked, reverted if necessary, and deployed across multiple environments with minimal effort. This feature facilitates maintaining consistency across deployments, as it eliminates the need for manual configuration and guarantees that infrastructure is created in a repeatable, reliable manner.

Alongside infrastructure management, this invention incorporates a streamlined application deployment workflow that is tightly integrated with IaC. The application deployment process begins with a developer committing code to a repository, which triggers a series of automated steps, including code compilation, quality checks, and unit testing. This invention's orchestrator monitors the progress of each step, ensuring that quality standards are met before the deployment process continues. By automating these steps, the invention removes the need for manual interventions, allowing applications to move through the deployment pipeline seamlessly. Additionally, the integration with IaC ensures that the application deployment workflow is aware of the infrastructure setup, enabling deployments to be synchronized with the infrastructure in a way that optimizes performance and reduces configuration mismatches. This synchronization is particularly valuable in environments with high compliance and performance requirements, where applications must be deployed in specific configurations to function effectively.

The invention features a release orchestrator that acts as the central control point, coordinating the interaction between infrastructure provisioning and application deployment workflows. This orchestrator operates on a parent-child workflow model, where the IaC workflow acts as the parent, and the application deployment workflow functions as the child. This hierarchical structure allows the orchestrator to manage dependencies between infrastructure and applications, ensuring that infrastructure provisioning is completed and validated before application deployment begins. This parent-child relationship enables precise control over the deployment order, minimizing risks associated with timing mismatches or dependency errors. For example, the orchestrator can confirm that a virtual machine has been provisioned, network configurations are in place, and security protocols are applied before launching the application deployment workflow. This approach ensures that applications are deployed into environments that are fully prepared to support their operational needs.

As part of its functionality, the invention includes a series of automated checks and validations designed to enhance the quality and security of deployments. Each deployment goes through a multi-stage validation process, where infrastructure and application configurations are checked against predefined standards. For instance, when infrastructure resources are provisioned, the system validates that network settings, storage configurations, and user permissions align with the security and performance requirements of the application. If any part of the configuration fails to meet these standards, the deployment process is halted, and the release orchestrator provides feedback to the development team. Similarly, the application code undergoes quality assurance checks, including code scans and unit testing, to detect potential issues before the application reaches production. This validation process is built into the orchestrator, ensuring that only secure, high-quality deployments proceed to production, reducing the risk of errors or vulnerabilities in the live environment.

The invention supports various deployment scenarios, offering flexibility for different organizational needs. One common scenario involves creating both new infrastructure and a new application deployment, where the entire environment is provisioned from scratch to meet specific application requirements. In this case, the IaC workflow provisions resources such as virtual machines, storage, and network configurations, while the application deployment workflow installs and configures the application in this new environment. Another scenario involves deploying an existing application onto newly created infrastructure, which allows legacy applications to be migrated to updated environments without extensive reconfiguration. This is particularly valuable in environments with legacy systems that need modernization. Additionally, the invention accommodates scenarios where the infrastructure is updated for an existing application, such as increasing server capacity or upgrading network settings. In these cases, the orchestrator manages the infrastructure updates without disrupting the application's availability, ensuring a smooth transition.

The invention places a strong emphasis on security, incorporating multiple layers of control and approval mechanisms into the deployment process. Before a deployment can proceed, it must go through an approval process where authorized personnel review and approve the deployment steps. This approval process is built into the release orchestrator, which logs each approval and creates an audit trail of user actions. The system integrates with LDAP for authentication and access control, allowing organizations to enforce role-based permissions and restrict access to specific deployment tasks. For instance, only designated administrators may have the authority to approve deployments or make changes to the infrastructure configuration. This layered security approach helps to safeguard sensitive environments, ensuring that unauthorized personnel cannot modify the deployment process or access restricted resources. By maintaining an audit trail, the system also facilitates compliance with regulatory requirements, making it easier to track deployment actions and verify adherence to security policies.

To further enhance adaptability, this invention is compatible with a wide range of infrastructure management and application deployment tools. While Terraform is used as the default IaC tool in the invention, the system is designed to integrate with other IaC solutions such as Azure Resource Manager, AWS CloudFormation, and Google Cloud Deployment Manager. This flexibility ensures that organizations can use the invention alongside their preferred infrastructure management tools without needing to overhaul their existing workflows. Similarly, the application deployment workflow is compatible with CI/CD platforms like Jenkins and GitLab, enabling seamless integration with development pipelines. This compatibility with diverse tools and platforms allows organizations to adopt the invention with minimal changes to their current technology stack, ensuring that they can benefit from hyper-automation without sacrificing their existing tools and practices.

A component of the invention is its centralized configuration management database, which tracks and manages infrastructure resources and configurations. Once infrastructure resources are provisioned, information such as IP addresses, storage configurations, and network settings is stored in this database, creating a central inventory of all deployment details. This configuration management database plays a pivotal role in maintaining consistency across deployments, as it allows the orchestrator to reference current configurations and validate that resources are correctly set up before proceeding with application deployment. By maintaining a single source of truth for infrastructure configurations, the invention reduces the risk of configuration drift, where resource settings change over time and become misaligned with application requirements. This database also simplifies troubleshooting by providing teams with quick access to accurate configuration information, allowing them to resolve issues more efficiently.

Another notable aspect of the invention is its pre-configuration of tech stacks before application deployment. When infrastructure is provisioned, the orchestrator installs essential software components and dependencies, such as programming languages, monitoring tools, and security protocols, on the virtual machines. This pre-configuration process, referred to as tech stack deployment, ensures that the environment is fully prepared to support the application. By automating this step, the invention removes the need for manual setup of dependencies, allowing application deployment to proceed immediately after infrastructure provisioning is complete. This tech stack deployment also enhances consistency across environments, as it ensures that each application is deployed on infrastructure with standardized configurations, reducing the likelihood of compatibility issues.

Dynamic scaling and resource optimization are integral to the invention, enabling it to adjust infrastructure resources in response to real-time application demand. The release orchestrator monitors resource usage and adjusts infrastructure capacity as needed, adding or removing resources based on factors such as application traffic and performance metrics. For instance, if an application experiences a spike in user activity, the system can provision additional virtual machines to accommodate the increased load, ensuring uninterrupted performance. This dynamic scaling capability is essential for optimizing costs, as it allows organizations to allocate resources only when they are needed, reducing expenses associated with over-provisioning. The orchestrator's ability to manage resource scaling autonomously allows organizations to achieve high levels of performance and efficiency without constant manual oversight.

To support robust monitoring and compliance, the invention includes extensive logging and monitoring features that track every action within the deployment workflow. Each step in the deployment process, from code commits to infrastructure provisioning, is logged and stored in the system's audit trail. These logs provide valuable insights into the deployment process, allowing teams to review past actions, analyze deployment times, and identify areas for improvement. Additionally, the system integrates with monitoring tools that track metrics related to application performance, resource health, and security. This monitoring capability allows teams to detect and address potential issues in real time, enhancing the reliability of the deployed applications. The logging and monitoring features are especially valuable for organizations with strict compliance requirements, as they provide a comprehensive record of all deployment activities.

The invention's architecture is designed with modularity in mind, utilizing a layered structure that separates core functionalities, security protocols, and user interface components. This layered architecture allows the system to be updated and maintained with minimal disruption to the overall workflow. For example, security protocols are managed in a separate layer, enabling updates to authentication methods or encryption standards without affecting the deployment process. Similarly, the user interface layer, which provides dashboards and reporting tools, can be customized to meet the specific needs of different users or departments. This modular approach enhances the adaptability of the invention, making it easier to implement updates and ensuring that the system can evolve alongside changes in technology and security standards.

The release orchestrator in this invention is highly configurable, allowing organizations to define custom workflows that align with their specific deployment needs. For instance, teams can set up unique deployment pipelines for different applications, environments, or compliance requirements. This flexibility is achieved through the use of templates, scripts, and policies that can be adjusted based on project-specific requirements. Custom workflows provide the invention with the versatility needed to support a wide range of deployment scenarios, from simple applications to complex, multi-tiered systems. This configurability enables organizations to tailor the deployment process to meet unique demands, ensuring that the invention can support their operational and regulatory needs effectively.

Reporting features in the invention offer detailed summaries of each deployment, covering aspects such as resource configurations, application versions, and deployment durations. These reports are generated automatically and are accessible through the system's user interface, providing teams with valuable insights into deployment efficiency and success rates. The reporting functionality is essential for tracking key performance indicators (KPIs), such as deployment speed, resource utilization, and error rates, enabling organizations to evaluate the effectiveness of their deployment strategies. By providing comprehensive reports, the invention allows teams to make data-driven decisions that enhance the overall quality and efficiency of their deployments.

The invention's ability to integrate infrastructure and application deployments into a cohesive, hyper-automated process is a significant advancement in deployment technology. Through the use of IaC, application workflows, security controls, and dynamic scaling, it creates a robust, scalable, and secure system that supports modern deployment needs. Its compatibility with various tools, layered architecture, centralized configuration management, and customizable workflows make it adaptable to diverse operational environments. This invention not only simplifies the deployment process but also enhances organizational agility by enabling faster, more reliable application releases across different environments and cloud platforms. The extensive automation and security features ensure that deployments meet high standards of quality, security, and efficiency, positioning the invention as an essential solution for organizations aiming to modernize and optimize their deployment practices.

In light of the foregoing, the following provides a simplified summary of the present disclosure to offer a basic understanding of its various parts. This summary is not exhaustive, nor does it limit the exemplary aspects of the inventions described herein. It is not designed to identify key or critical elements or steps of the disclosure, nor to define its scope. Rather, it is intended, as understood by a person of ordinary skill in the art, to introduce some concepts of the disclosure in a simplified form as a precursor to the more detailed description that follows. The specification throughout this application contains sufficient written descriptions of the inventions, including exemplary, non-exhaustive, and non-limiting methods and processes for making and using the inventions. These descriptions are presented in full, clear, concise, and exact terms to enable skilled artisans to make and use the inventions without undue experimentation, and they delineate the best mode contemplated for carrying out the inventions.

In some arrangements, a method for hyper-automating the deployment of applications with integrated infrastructure provisioning includes providing, by a configuration repository, a version-controlled storage of infrastructure as code (IaC) scripts defining infrastructure configurations necessary for application deployment. The method involves committing, by a user, an infrastructure code change to the configuration repository, which initiates a build orchestrator to execute a continuous integration process. The build orchestrator triggers automated steps, including code quality scanning, unit testing, packaging, and artifact storage in an artifact repository to ensure the integrity of the infrastructure code. The release orchestrator then initiates an IaC platform to execute the provision of infrastructure resources, as defined in the IaC scripts stored in the configuration repository, creating the necessary infrastructure environments, such as virtual machines, storage, and network configurations. The release orchestrator validates the provisioned infrastructure by checking for successful execution and ensuring compliance with predefined security, network, and performance requirements. It also updates the provisioned infrastructure information in a configuration management database for consistency and traceability. A tech stack deployment module installs essential software dependencies on the provisioned infrastructure, preparing the environment for application deployment. The release orchestrator triggers an application deployment workflow by activating an application deployment module to install and configure application artifacts within the provisioned infrastructure. Automated application quality checks and performance validation are conducted to ensure the application functions correctly. The release orchestrator dynamically scales the provisioned infrastructure based on real-time application demand, logging each step of the deployment process in a centralized monitoring system. A security module enforces an approval process requiring authorization before deploying or scaling infrastructure. Finally, a reporting module provides detailed deployment summaries to improve deployment processes and compliance.

In some arrangements, the method includes a configuration repository that supports version control systems, such as Git, Subversion, Mercurial, and other distributed or centralized systems, enabling collaborative management and tracking of IaC scripts.

In some arrangements, the method further includes the build orchestrator performing additional automated steps, such as static code analysis to detect vulnerabilities or inefficiencies, ensuring compliance with organizational coding standards.

In some arrangements, the method includes the code quality scanning step identifying code patterns that could lead to misconfigurations or security risks, such as incorrect permissions, improper network configurations, or unoptimized resource allocation.

In some arrangements, the method includes unit testing of IaC components, simulating infrastructure creation in a controlled test environment to verify the functionality and compatibility of each component prior to production deployment.

In some arrangements, the method includes the artifact repository storing and managing multiple versions of validated scripts, allowing rollback to previous versions in case of deployment issues.

In some arrangements, the method includes the IaC platform executing infrastructure provisioning by interfacing with cloud provider APIs, such as those of AWS, Azure, and Google Cloud Platform, to dynamically create and configure resources in cloud environments.

In some arrangements, the method includes the IaC platform's capability to provision hybrid infrastructure environments, integrating both on-premises data centers and cloud resources for specific deployment requirements.

In some arrangements, the method includes the release orchestrator performing post-provisioning compliance checks by cross-referencing infrastructure configurations with predefined security policies, including network access controls and encryption standards.

In some arrangements, the method includes the configuration management database storing metadata for each provisioned resource, such as creation timestamps, version identifiers, and dependency relationships, to facilitate resource lifecycle management.

In some arrangements, the method includes a tech stack deployment module pre-configured with libraries and toolsets supporting containerized environments, such as Docker and Kubernetes, allowing deployment of applications in containerized or microservices architectures.

In some arrangements, the method includes the application deployment module retrieving application-specific configuration files from the artifact repository, ensuring application settings dynamically adjust based on the deployment environment.

In some arrangements, the method includes the application deployment module's rollback feature, which automatically reverts to a previous stable version of the application in the event of deployment failure.

In some arrangements, the method includes the application deployment module conducting performance validation by stress-testing the application under high load conditions to ensure scalability and reliability.

In some arrangements, the method includes the centralized monitoring system generating real-time alerts for deployment anomalies, such as failed infrastructure provisioning or performance bottlenecks, enabling proactive troubleshooting.

In some arrangements, the method includes the security module integrated within the release orchestrator supporting multifactor authentication for accessing the approval process, enhancing security in production environments.

In some arrangements, the method includes the reporting module providing customizable reports detailing deployment metrics, error trends, and resource utilization forecasts, supporting data-driven decision-making for future deployments.

In some arrangements, a system for hyper-automating the deployment of applications with integrated infrastructure provisioning includes a configuration repository to store and manage IaC scripts in a version-controlled environment, tracking modifications to scripts that define resources, network settings, security policies, and other deployment parameters. A build orchestrator communicates with the repository to detect changes and initiates a continuous integration pipeline that validates IaC scripts for syntax, quality, and compliance. The system has an artifact repository for storing validated scripts, a release orchestrator coordinating infrastructure and application deployment workflows, and an IaC platform interfacing with APIs or data centers to provision resources. Additionally, the system includes a configuration management database to store provisioned infrastructure data, a tech stack deployment module to deploy essential dependencies, and an application deployment module to retrieve and install application artifacts. The system uses a centralized monitoring system to log deployment steps, a performance monitoring system for dynamic scaling, a security module for enforcing approval protocols, and a reporting module providing insights into deployment efficiency and resource use.

In some arrangements, the system includes a machine learning module within the build orchestrator, configured to analyze historical deployment data and code quality metrics stored in the artifact repository and configuration management database. This machine learning module performs pattern recognition to identify common causes of deployment errors, trend analysis on recurring issues in code quality, predictive failure analysis by evaluating real-time data, and adaptive learning from user feedback on deployment outcomes. This module refines its prediction models and recommendation algorithms based on past deployments, enhancing the system's ability to optimize infrastructure code quality and deployment reliability.

In some arrangements, a method for hyper-automating the deployment of applications with integrated infrastructure provisioning includes storing, by a configuration repository, version-controlled IaC scripts defining infrastructure configurations. The build orchestrator initiates a continuous integration pipeline upon detecting changes in the IaC scripts, performing syntax validation, quality scans, and unit testing, and the artifact repository stores validated IaC scripts for traceability. A release orchestrator triggers the IaC platform to provision resources, and it verifies infrastructure compliance with security and configuration standards. The release orchestrator updates a configuration management database with resource details, while a tech stack deployment module installs software dependencies on the infrastructure. The application deployment module retrieves application artifacts and applies environment-specific configurations, monitored by a centralized system for real-time status tracking. The system dynamically scales resources based on demand, and the security module enforces approval workflows for production changes. Lastly, the reporting module provides detailed deployment insights to stakeholders, supporting optimized and compliant deployment operations.

The following description and claims, in conjunction with the drawings—all integral parts of this specification—will clarify various features and characteristics of the current technology. Like reference numerals in the figures correspond to similar parts, enhancing understanding of the technology's methods of operation and the functions of related structural elements, as well as the synergies and economies of their combinations. Some of the processes or procedures described here may be implemented, in whole or in part, as computer-executable instructions recorded on computer-readable media, configured as computer modules, or in other computer constructs. These steps and functionalities may be executed on a single device or distributed across multiple devices interconnected with one another. However, it is important to acknowledge that the drawings primarily serve for descriptive and illustrative purposes and are not intended to delineate the limits of the invention. Unless contextually evident, the singular forms of “a,” “an,” and “the” used throughout the specification and claims should be interpreted to include their plural counterparts.

### BRIEF DESCRIPTION OF DRAWINGS

FIG. 1 depicts separate workflows for infrastructure as code (IaC) deployment and application deployment, illustrating the stages from development to deployment for each process.

FIG. 2 depicts a combined workflow integrating both IaC and application deployment processes, where the release orchestrator coordinates infrastructure and application tasks into a cohesive deployment sequence.

FIG. 3 depicts a sample technical solution architecture with modules for IaC, application CI/CD, and various deployment scenarios, demonstrating how the orchestrator manages different use cases, such as new or updated infrastructure and applications.

FIG. 4 depicts a sample end-to-end deployment workflow, where the orchestrator triggers infrastructure and application deployments while incorporating security, approvals, and integration with external systems.

FIG. 5 depicts a sample sequence diagram illustrating the hyper-automated deployment process, starting from the initial code commit in the configuration repository and progressing through code validation, infrastructure provisioning, application deployment, monitoring, and reporting. The figure highlights interactions among key components such as the build orchestrator, release orchestrator, IaC platform, and security and monitoring modules to ensure a reliable, secure, and scalable deployment.

### DETAILED DESCRIPTION

This invention provides a comprehensive solution for hyper-automating the deployment of applications alongside infrastructure provisioning by unifying two traditionally separate workflows into a seamless, efficient, and secure system. Through the use of infrastructure as code (IaC), the system manages infrastructure configurations via scripts stored in a version-controlled configuration repository, allowing consistency, traceability, and control over all infrastructure aspects. This version-controlled repository stores IaC scripts defining configurations for resources, network setups, security policies, and dependencies, providing the basis for consistent, automated infrastructure creation across deployment environments.

A build orchestrator is configured to monitor changes in the IaC scripts stored in the configuration repository. When changes are detected, the build orchestrator initiates a continuous integration pipeline that performs automated checks on the scripts, such as syntax validation, code quality analysis, and unit testing, to ensure they meet organizational and technical standards for deployment. These validated IaC scripts are then stored in an artifact repository, where they are maintained in multiple versions, allowing for easy rollbacks and traceability, which helps minimize deployment risks. The artifact repository also provides storage for verified infrastructure configurations, ensuring that only compliant and error-free scripts are used for provisioning.

Once the IaC scripts have been verified, a release orchestrator coordinates the infrastructure provisioning and application deployment workflows, acting as a central control point that enables full automation of the process. The release orchestrator triggers an IaC platform that provisions infrastructure resources according to the specifications in the IaC scripts. This platform interfaces with various cloud provider APIs or on-premises systems, allowing the system to create and configure resources, including virtual machines, storage, and network components, across different environments. The flexibility to interact with both cloud and on-premises systems ensures that the system can support hybrid deployment environments, meeting diverse infrastructure needs and optimizing resource use.

After the infrastructure is provisioned, the release orchestrator performs compliance checks to ensure that the infrastructure meets predefined security, performance, and network policies. This includes verifying that all created resources align with the organization's standards and regulatory requirements, which helps ensure reliability, security, and operational consistency. The system then updates a configuration management database with information on the provisioned infrastructure, such as resource identifiers, IP addresses, and version data, ensuring an accurate, real-time record of current infrastructure states. This database also supports audits and traceability by providing a centralized source of truth for all infrastructure resources.

With the infrastructure in place, a tech stack deployment module installs essential software dependencies, runtime environments, and security protocols on the provisioned infrastructure, preparing the environment for application deployment. The tech stack deployment module includes libraries, monitoring tools, and other prerequisites that are required to support the target applications. This step minimizes the manual setup needed for infrastructure readiness, helping ensure the environment is consistent and fully prepared to host applications immediately after provisioning. By standardizing these dependencies, the system reduces the risk of configuration mismatches and improves the stability of application deployments.

The application deployment process is also managed by the release orchestrator, which triggers an application deployment module to retrieve application artifacts from the artifact repository. This module installs and configures these artifacts on the provisioned infrastructure according to the application's specific requirements and dependencies. Environment-specific configurations are applied, ensuring that the application is set up in alignment with the underlying infrastructure, which further reduces the likelihood of deployment failures due to mismatches. Additionally, the application deployment module performs automated quality checks, including functional verification and load testing, to ensure that the application meets required standards for performance and functionality.

Once deployed, the system continuously monitors application performance and resource usage through a centralized monitoring system. Each step of the deployment process, from infrastructure provisioning to application deployment, is logged to create a comprehensive audit trail, enabling real-time status updates and troubleshooting support. This centralized monitoring system also provides insights into deployment health, allowing operators to quickly identify and address any issues that arise. The monitoring system is an essential feature for maintaining visibility and control over deployments, especially in complex environments where multiple applications and resources are being managed simultaneously.

Dynamic scaling is another core aspect of the invention, allowing the release orchestrator to adjust infrastructure resources automatically based on real-time application demand. The system monitors metrics such as CPU, memory, and network usage to determine when additional resources, such as virtual machines or network bandwidth, are required. By scaling resources in response to actual needs, the system optimizes infrastructure use, reduces operational costs, and ensures that applications maintain high performance levels even during peak usage. This dynamic scaling is essential for modern applications that experience fluctuating workloads, as it provides the flexibility to adapt to changing demands without requiring manual intervention.

To secure the deployment process, a security module is integrated within the release orchestrator, enforcing access controls and managing an approval workflow that requires authorization before any deployment or scaling action is performed in production environments. This security module supports multifactor authentication and restricts access to deployment functions, ensuring that only authorized personnel can make changes. These security protocols help protect sensitive infrastructure and application environments, reducing the risk of unauthorized access and improving compliance with organizational and regulatory standards. Security audits and approvals are logged, further strengthening the system's compliance capabilities.

The system also includes a comprehensive reporting module that generates detailed reports on deployment metrics, error rates, resource utilization, and historical data for each deployment. These reports are accessible through a user interface, providing stakeholders with valuable insights that support data-driven decision-making and continuous improvement of deployment processes. By analyzing trends and patterns within deployment metrics, operators can identify areas for optimization, improve resource allocation, and reduce potential failure points in future deployments. The reporting module is an important tool for maintaining transparency, supporting strategic planning, and ensuring the long-term success of deployment operations.

A machine learning module within the build orchestrator enhances the system's capability by analyzing historical deployment data and code quality metrics stored in the artifact repository and configuration management database. This machine learning module performs pattern recognition, identifying common causes of deployment errors and recommending adjustments to IaC scripts to improve infrastructure configurations. It also conducts trend analysis, detects recurring issues, and provides predictive failure analysis by comparing real-time data against historical patterns to flag potential issues before they occur. The adaptive learning feature refines the system's prediction models and recommendation algorithms based on feedback from previous deployments, making it an increasingly effective tool for optimizing deployment reliability.

This invention thus provides a robust, scalable, and secure framework for managing the entire lifecycle of application and infrastructure deployments in a unified workflow. By automating both infrastructure provisioning and application deployment, it reduces manual intervention and the associated risk of human error. The integration of dynamic scaling, monitoring, security controls, and compliance features ensures that deployments are efficient, secure, and aligned with organizational standards. The invention's use of IaC, combined with centralized control through the release orchestrator, facilitates a standardized approach to infrastructure and application setup across multiple environments, simplifying complex deployment processes and improving operational consistency.

Through its flexible architecture, this invention is compatible with a wide range of deployment tools and platforms, allowing organizations to use it alongside their preferred infrastructure management systems, CI/CD platforms, and cloud providers. By leveraging common APIs and deployment protocols, the system integrates seamlessly with existing IT ecosystems, supporting organizations as they modernize and scale their infrastructure. This adaptability is essential for meeting the diverse needs of modern businesses, where deployment environments may span public clouds, private clouds, and on-premises systems.

This hyper-automation approach to application deployment with integrated infrastructure provisioning offers a comprehensive solution for managing complex deployments in real-time, reducing costs, and optimizing resources. The centralized orchestration, dynamic scaling, and detailed reporting make it an ideal choice for organizations looking to improve deployment efficiency, maintain security and compliance, and meet the performance demands of modern applications. By unifying infrastructure and application workflows, this invention establishes a streamlined deployment process that enhances organizational agility and responsiveness in a rapidly evolving technological landscape.

The description of various example embodiments herein is intended to achieve the goals previously outlined, referencing the illustrations included in this disclosure. These illustrations depict multiple systems and methods for implementing the disclosed information. It should be recognized that alternative implementations are possible, and modifications to both structure and functionality may be made. The description details various connections between elements, which should be interpreted broadly. Unless explicitly stated otherwise, these connections can be either direct or indirect and may be established through either wired or wireless methods. This document does not aim to restrict the nature of these connections.

In various configurations, terms such as “computers” and “machines” refer to devices that may be general-purpose or specialized for specific tasks, whether physical or virtual, and capable of network connectivity. These devices encompass all necessary hardware, software, and components known to skilled practitioners, including application-specific integrated circuits (ASICs), microprocessors, cores, or other processing units. These components execute, control, or implement various types of software, instructions, data, modules, processes, or routines. The terms used do not restrict the device type and should be broadly interpreted. Software, data, and executable code can reside on various physical, computer-readable storage devices, such as local memory, cloud-based storage, or network-attached storage. These can be stored in both volatile and non-volatile memory and may function autonomously or respond to specific triggers. These elements can be consolidated or distributed across multiple devices and stored in accessible memory systems such as distributed databases, big data infrastructures, blockchains, or distributed ledgers.

Networks and similar references refer to a broad range of communication systems, from local area networks (LANs) and wide area networks (WANs) to the Internet and cloud-based networks, supporting wired and wireless configurations. Specialized networks like digital subscriber line (DSL), frame relay, asynchronous transfer mode (ATM), and virtual private networks (VPN) are included. These networks utilize various hardware and software components, including modems, routers, firewalls, switches, and adapters, to facilitate communication. Networks are also equipped with virtual IP addresses and support multiple protocols like HTTPS, enabling effective packet-based data transmission and communication.

Generative Artificial Intelligence (AI) refers to AI techniques that learn from training data and generate new content, such as text, code, images, and audio. Generative AI systems, often powered by large language models (LLMs) like GPT-3, GPT-4, Meta LLaMA, and others, can be deployed through APIs, search engines, or chatbots. These models, which may be proprietary or open source, leverage deep learning methods and are generally governed by enterprise policies regarding AI and risk. Models such as BERT, T5, AlphaFold, Watson, Megatron, and others play a role in generating or interpreting language and content for various applications.

Generative AI and LLMs are utilized throughout this disclosure for tasks including natural language processing, data analysis, real-time processing, software development, and creative content generation. Specific functions include trend analysis, data classification, sentiment analysis, writing assistance, language translation, and decision-making support. These models enable capabilities like feedback learning, context determination, and comprehensive search operations, improving performance through iterative learning and feedback from human or system interactions. The wide range of applications supported by generative AI makes these systems a powerful tool in generating, analyzing, and managing information across diverse fields. All configurations and uses of these models are within the scope of this disclosure.

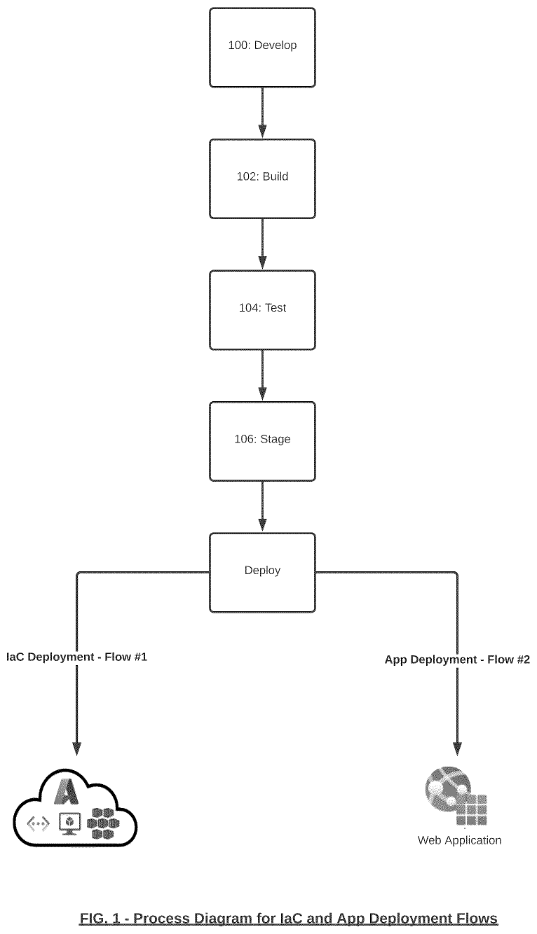

FIG. 1 illustrates a detailed process diagram for hyper-automated application deployment with infrastructure provisioning, showcasing two distinct workflows: IaC Deployment (Flow #1) and App Deployment (Flow #2). The flow starts with the development stage (100), where the initial infrastructure code and application code are created and refined by developers. This code is configured as infrastructure as code (IaC) scripts, defining essential infrastructure configurations, such as virtual machines, network settings, security policies, and storage resources, which are then stored in a configuration repository. In the build stage (102), a build orchestrator, monitoring for any changes in the codebase, detects the updates and initiates a continuous integration pipeline. This orchestrator automatically validates the code syntax, assesses the code quality, and verifies the integrity of the scripts. During this phase, the IaC scripts and application code undergo quality checks, including static code analysis and unit testing, ensuring they meet organizational and technical standards necessary for deployment.

In the test stage (104), more rigorous checks are performed to ensure both the infrastructure and application code are stable and aligned with the organization's performance and security requirements. Here, tests may include both automated unit tests and controlled simulations that validate the infrastructure configurations defined in the IaC scripts. These tests play a role in verifying that the configuration files are logically sound, can provision the required resources, and do not contain vulnerabilities or inefficiencies that could affect the stability and security of the deployment. Following successful testing, the validated scripts and artifacts progress to the staging phase (106), where they are prepared for deployment in a test environment that closely mimics production. In this staging environment, further validation and integrity checks ensure the infrastructure and application deployment processes will execute as intended.

After successful completion of staging, the deployment processes diverge into two workflows: IaC Deployment (Flow #1) and App Deployment (Flow #2). In Flow #1 (IaC Deployment), the release orchestrator, having initiated the IaC platform, provisions the necessary infrastructure resources as defined in the IaC scripts. This includes interfacing with various cloud provider APIs, on-premises data centers, or hybrid environments to dynamically create resources such as virtual machines, storage allocations, and network configurations. Throughout this IaC deployment phase, the orchestrator coordinates with a configuration management database to log infrastructure resources and verify that they meet compliance, security, and performance requirements. The deployment of infrastructure includes checks to confirm that network access controls, security protocols, and configuration policies adhere to predefined standards.

In parallel, Flow #2 (App Deployment) progresses as the release orchestrator triggers the application deployment module to retrieve application artifacts stored in an artifact repository. The application deployment module installs and configures these artifacts on the provisioned infrastructure according to the application's specific requirements and dependencies. This installation process ensures that the application aligns with the underlying infrastructure to maintain performance and functionality. During this phase, environment-specific configurations are applied to the application, adapting it to the current deployment setting. Functional verification tests, load testing, and security vulnerability scans are conducted to confirm the application's performance, reliability, and compatibility with the infrastructure.

The overall architecture shown in FIG. 1 underscores a hyper-automated, unified approach to deployment where both the infrastructure and application deployments are orchestrated to work in tandem. By separating the workflows into IaC and application deployment flows, the system ensures that infrastructure provisioning and application setup proceed smoothly and cohesively. This configuration minimizes manual interventions and reduces the likelihood of deployment errors due to misaligned configurations. The orchestration of these flows enables dynamic scaling capabilities, real-time monitoring, security controls, and comprehensive reporting, providing a robust framework for reliable and efficient deployments.

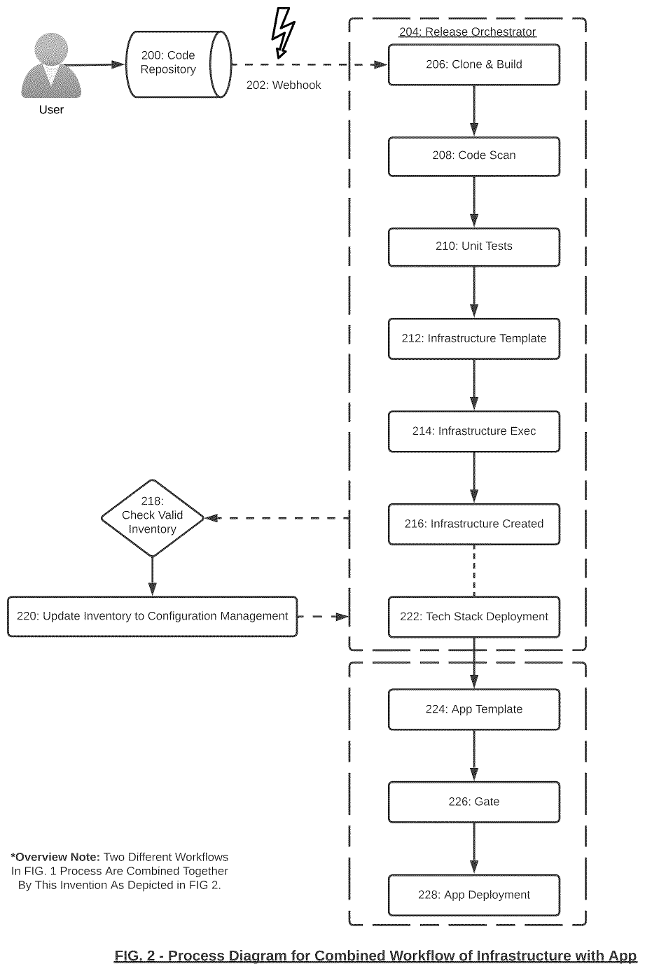

FIG. 2 illustrates an intricate, integrated workflow for hyper-automating application deployment along with infrastructure provisioning, highlighting the way in which Infrastructure as Code (IaC) and application deployment processes are unified into a single cohesive flow. The workflow begins with a user initiating the deployment sequence by committing code to the code repository, designated as element 200 in the figure. This repository contains the latest infrastructure and application code required for deployment, providing a controlled environment for version management, where changes can be tracked and reverted if necessary. Upon detecting this code submission, a webhook, represented as element 202, is automatically triggered. This webhook acts as a signal to the system, notifying it that new code changes are available and initiating the deployment pipeline without requiring manual intervention. The automated triggering by the webhook sets off a chain of orchestrated actions that systematically carry the IaC and application code through various stages of validation, provisioning, and deployment.

After the webhook initiates the pipeline, the process advances to the clone and build stage, labeled as 206. Here, the build orchestrator retrieves the latest version of the infrastructure and application code from the repository, ensuring that all modifications made by the user are accurately reflected in the build. This step is essential for maintaining consistency between the code submitted and the code that is subsequently tested and deployed. During this build stage, the system verifies the code to eliminate discrepancies that could arise if outdated or incorrect versions were used. Once the code is cloned, the build orchestrator performs a series of checks to confirm that the code meets the required quality and security standards. The next step in this workflow is the code scan, marked as element 208, where the system undertakes an in-depth examination of the IaC and application code. This scan is essential to detect any potential misconfigurations, security vulnerabilities, or code inefficiencies that could jeopardize the deployment. The code scan may include static analysis, which reviews the code structure, adherence to coding standards, and flags any insecure practices, such as hardcoded credentials or exposed endpoints, that could expose the system to risk.

Following the code scan, the system advances to unit tests, represented as element 210. Unit testing is a step where individual components of the code, particularly the infrastructure configurations defined in the IaC scripts, are isolated and tested to ensure they perform their expected functions correctly. This phase helps detect any functional issues in individual infrastructure components before they are assembled into a complete deployment. For instance, unit testing could verify that specific resource configurations, such as virtual machine settings or network policies, conform to predefined specifications. By validating each component in isolation, unit testing increases the reliability of the deployment process, reducing the risk of errors in the combined workflow.

With the infrastructure and application code validated, the process generates an infrastructure template, indicated as element 212. This template contains a comprehensive blueprint of the resources and configurations needed to provision the infrastructure, including specific requirements such as virtual machines, storage allocations, network settings, and security policies. The infrastructure template serves as a blueprint for the following steps, ensuring that the infrastructure is provisioned consistently across different environments. The infrastructure exec stage, labeled as element 214, then uses this template to initiate the actual provisioning of resources. During this phase, the IaC platform interacts with various cloud provider APIs, hybrid cloud systems, or on-premises environments to create and configure the infrastructure resources. The flexibility of the IaC platform enables it to support various deployment environments, whether cloud-based or local, ensuring that resources are provisioned in a manner that aligns with the predefined requirements in the infrastructure template.

Once the infrastructure has been created, the system confirms successful execution by verifying each provisioned resource, designated as infrastructure created in element 216. This verification process involves detailed checks to ensure that all resources have been accurately configured and are fully operational, with security policies, network configurations, and resource allocations adhering to organizational standards. For example, the system may verify that virtual machines have the correct processing power and storage, that network configurations comply with access control policies, and that security settings meet compliance standards. Only when the infrastructure meets all required specifications does the system proceed to the next phase of the workflow.

The next step is check valid inventory, shown as element 218. In this step, the system cross-references the infrastructure against the configuration requirements, validating the completeness and functionality of the deployed resources. This validation process is designed to ensure that all components are correctly deployed, connected, and ready to support application deployment. Once the inventory check confirms the infrastructure's validity, the process moves to update inventory to configuration management, represented as element 220. In this step, the configuration management database is updated with comprehensive details about the provisioned infrastructure, including metadata such as IP addresses, instance types, configuration versions, and security settings. This information provides a centralized and accurate inventory of infrastructure resources, supporting auditability and compliance and ensuring traceability across deployments.

With the infrastructure now fully established and validated, the workflow transitions to application-specific preparation steps. The next phase is tech stack deployment, identified as element 222. During this phase, essential software dependencies, libraries, and runtime environments are installed on the provisioned infrastructure to prepare it for application deployment. This includes installing any necessary programming environments, monitoring tools, and security protocols that the application requires to function optimally. This step is essential for creating a compatible and stable environment where the application can be deployed without additional manual setup, reducing the likelihood of deployment failures due to missing dependencies.

The app template, marked as element 224, is retrieved next, containing detailed configuration settings and environment-specific parameters required for deploying the application onto the prepared infrastructure. This template ensures that the application is configured in alignment with the underlying infrastructure, supporting optimal performance and compatibility. Before advancing to full application deployment, the gate, designated as element 226, enforces security protocols and requires explicit approval from authorized personnel. This security measure helps prevent unauthorized changes or unapproved configurations from being deployed in production environments. By instituting this gate, the system ensures that only verified and approved applications progress further in the deployment pipeline, reinforcing security and compliance standards.

Finally, the app deployment phase, shown as element 228, installs and configures the application on the provisioned infrastructure. The application deployment module retrieves the necessary artifacts from the artifact repository, installs them onto the infrastructure, and applies any environment-specific configurations specified in the app template. Additional quality checks, such as functional verification and performance testing, may be performed at this stage to confirm the application operates as expected. This deployment phase ensures that the application is fully operational, compatible with the underlying infrastructure, and meets the organization's performance, security, and compliance standards.

FIG. 2 represents a unified, hyper-automated workflow that integrates both infrastructure and application deployment processes in a structured, efficient manner. By combining the IaC and application workflows, the system eliminates manual steps, reduces the potential for errors, and accelerates deployment timelines. The orchestration of these processes through automated triggers, approvals, and validations ensures that the deployment is consistent, secure, and in compliance with the organization's standards, enhancing both the speed and reliability of the entire deployment lifecycle.

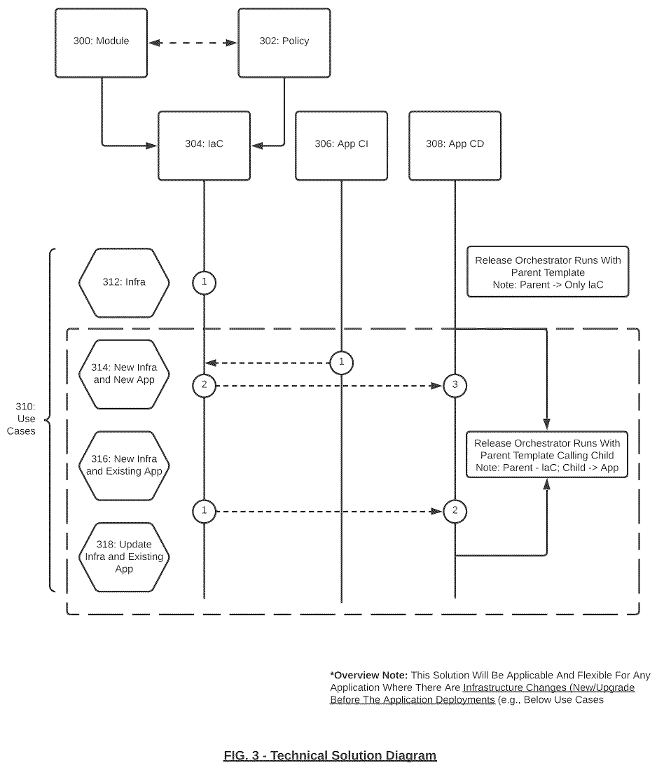

FIG. 3 presents an intricate technical solution diagram for the hyper-automated system of application deployment with infrastructure as code (IaC), showcasing the interconnections and dependencies among core modules essential for achieving a unified and efficient deployment workflow. The diagram begins with the central module (300), which orchestrates the flow of data and commands between various components of the system, ensuring that each process involved in both infrastructure and application deployment is tightly coordinated. This central module is designed to enforce logical dependencies, allowing the system to proceed in an organized, step-by-step manner that reduces the potential for errors during deployment.

Adjacent to the central module, policy (302) represents the framework of security protocols, compliance requirements, and operational guidelines that govern the deployment process. This policy module ensures that every aspect of the deployment, from infrastructure provisioning to application installation, adheres to predefined standards and regulatory requirements. For instance, the policy module might specify access control protocols, data encryption standards, and resource allocation guidelines, all of which ensure that the system remains secure, compliant, and operationally consistent across diverse deployment environments.

FIG. 3 highlights the presence of two major workflows within the system: IaC (304) and App CI (306). The IaC component serves as the core of the infrastructure provisioning workflow, allowing infrastructure to be defined and managed entirely through code. By leveraging IaC, the system can dynamically create resources such as virtual machines, storage, network configurations, and security settings based on templates and specifications stored in the configuration repository. IaC ensures that infrastructure is provisioned consistently, reliably, and with a minimal need for manual intervention. The App CI (306) module, or Continuous Integration for applications, automates the process of code validation, testing, and artifact generation for the application. This module retrieves application code from the repository, performs automated tests to verify code integrity, and packages the application into deployable artifacts. Together, IaC and App CI form the foundational workflows required for deploying infrastructure and applications.

The system also features App CD (308), or Continuous Deployment, which is tightly integrated with the App CI module. App CD automates the final stages of the application deployment process, including retrieving artifacts generated in the App CI phase, applying configuration settings, and deploying the application to the provisioned infrastructure. This integration ensures that once the application code passes the continuous integration stage, it seamlessly progresses into deployment without additional manual steps. By connecting App CI and App CD, the system enables a smooth, continuous deployment pipeline, enhancing efficiency and reliability in the application deployment lifecycle.

The diagram further emphasizes three essential use cases managed by the system, represented by use cases (310) and numbered as new infrastructure and new app (314), new infrastructure and existing app (316), and update infrastructure and existing app (318). These use cases demonstrate the flexibility of the system in handling different deployment scenarios. In the new infrastructure and new app use case (314), the system provisions an entirely new infrastructure environment and deploys a newly developed application onto it. This scenario may be used when an organization launches a new service or product requiring dedicated resources from the outset. For new infrastructure and existing app (316), the system provisions fresh infrastructure resources but deploys an already-existing application. This use case is beneficial when migrating legacy applications to a modernized environment, such as transitioning from on-premises infrastructure to cloud-based resources. The update infrastructure and existing app use case (318) addresses the need to modify or expand current infrastructure for an application already in production. In this scenario, the system may, for example, increase resource allocations, such as adding memory or compute power, to handle increased demand or adjust to new performance requirements without disrupting the existing application setup.

Central to the orchestration process, the release orchestrator (312) is shown with two distinct operations. First, the release orchestrator runs using a parent template that calls a child template, in which the parent is responsible for provisioning infrastructure through IaC, while the child handles the deployment of the application itself. This parent-child relationship enables the orchestrator to manage dependencies and control the sequence of operations so that infrastructure is fully provisioned and validated before the application is deployed. This hierarchical approach minimizes the risk of deployment failures due to unprepared infrastructure. The second operational mode shows the release orchestrator running only with the IaC as the parent template, indicating that the orchestrator can adapt depending on the complexity or specific requirements of each deployment. This flexibility allows the orchestrator to cater to both comprehensive, multi-step deployments and more streamlined, infrastructure-only deployments.

The technical solution depicted in FIG. 3 underscores the ability of the system to support varied and complex deployment environments, meeting the needs of modern enterprises that require a reliable, scalable, and compliant solution for infrastructure and application deployments. Each module, use case, and orchestrator function works together to maintain a high degree of automation, consistency, and security throughout the deployment process, while the system's modular design allows for customization and scalability, making it adaptable to diverse environments and evolving operational requirements. Through its combination of IaC, continuous integration and deployment, hierarchical orchestrator functions, and policy enforcement, the system provides a robust, end-to-end solution for hyper-automating deployments across multiple use cases and deployment scenarios.

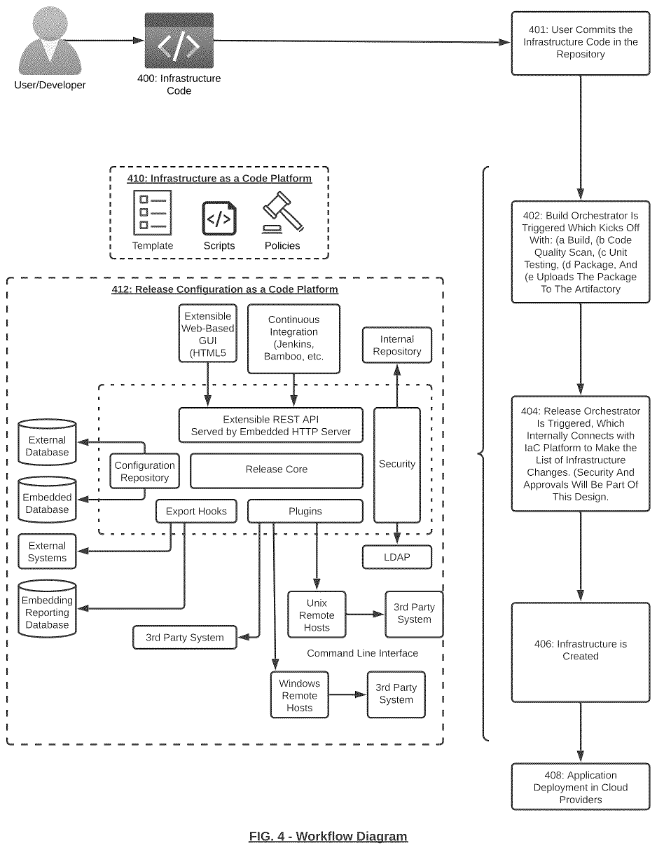

FIG. 4 presents a sample detailed depiction of a hyper-automated deployment workflow, illustrating the entire process of application deployment integrated with infrastructure provisioning within a structured, interconnected system. The workflow begins with infrastructure code, denoted by 400, which encapsulates the entire infrastructure setup required for deployment, including virtual machines, network configurations, storage allocations, and security settings. This infrastructure code is constructed based on the principles of Infrastructure as Code (IaC), a method that allows the entire configuration of infrastructure to be managed, versioned, and automated as code. By structuring infrastructure as a set of code scripts, this system ensures that infrastructure configurations are repeatable, traceable, and modifiable with precision, laying a foundation for consistency across multiple deployment environments.

Once the infrastructure code has been authored, a user commits this code to the designated repository, shown in element 401, which functions as a secure, version-controlled storage solution. The repository serves as the primary point of reference for all infrastructure definitions, allowing the system to track changes, revert to previous versions, and maintain a historical record of each infrastructure state. This repository plays a role in promoting transparency and traceability, as every adjustment to the infrastructure code is logged, time-stamped, and preserved, which is essential for audits, compliance, and configuration management.

Upon the commit of the infrastructure code to the repository, the build orchestrator, represented as element 402, is triggered automatically, initiating a sequence of validation and build steps necessary to prepare the infrastructure code for deployment. The build orchestrator undertakes multiple tasks, including compiling the code, performing code quality scans, executing unit tests, packaging the validated code, and uploading the resulting package to an artifact repository for secure storage. During the code quality scan phase, the build orchestrator analyzes the code for potential vulnerabilities, inefficiencies, and inconsistencies with organizational standards. This phase ensures that any risks are mitigated early in the process, safeguarding the stability and security of the infrastructure before deployment.

Following the build process, control passes to the release orchestrator, indicated by 404. The release orchestrator is the central engine that coordinates the entirety of the deployment process, managing both the infrastructure provisioning and the subsequent application deployment in an orchestrated workflow. Upon activation, the release orchestrator connects to the IaC platform to generate a comprehensive list of infrastructure changes required by the deployment. These changes are represented by each infrastructure component specified in the IaC code, such as compute instances, network routes, storage blocks, and access policies. To ensure compliance with security and operational standards, the release orchestrator integrates security checks into the workflow, requiring approvals from authorized personnel as part of the infrastructure provisioning process. This design mitigates risks by enforcing security controls and preventing unauthorized configurations from being implemented.

After these preliminary checks, the infrastructure is provisioned, as depicted by element 406, where the IaC platform interfaces directly with cloud providers or on-premises resources to create and configure the necessary infrastructure elements. This phase automates the establishment of infrastructure resources, with each component configured precisely according to the details in the IaC code, enabling a high degree of consistency across environments. Each provisioned component, such as virtual machines or databases, is created with the exact specifications required, reducing potential misconfigurations and errors that could arise from manual setup. This stage is essential for ensuring the underlying infrastructure is ready to support the application deployment.

As the infrastructure provisioning concludes, the workflow transitions to the application deployment phase, represented by application deployment in cloud providers as shown by element 408. During this phase, the application artifacts, which may include executable files, libraries, and configuration settings, are deployed onto the newly provisioned infrastructure. The application deployment module retrieves these artifacts from a centralized repository, applying any necessary configuration adjustments based on the specific environment where the application is deployed. This deployment is conducted in a highly controlled manner, ensuring the application components align with the infrastructure's architecture and operational requirements, thereby maximizing performance and minimizing compatibility issues.

The infrastructure as a code platform, indicated by element 410, plays a foundational role throughout this entire workflow. This platform serves as the control hub for all infrastructure configurations, enabling the precise management of each infrastructure component through code. The IaC platform supports a variety of environments, including multi-cloud, hybrid cloud, and on-premises deployments, making it adaptable to diverse infrastructure needs. By utilizing IaC, the platform facilitates seamless integration across different deployment environments, ensuring that infrastructure setups are not only consistent but also flexible enough to adapt to evolving organizational needs or varying workload demands.

Element 410 also represents a broad range of interfaces and integrations designed to extend the system's capabilities. A web-based GUI built with HTML5 provides users with an accessible, intuitive interface for managing deployments, visualizing infrastructure states, and monitoring real-time deployment status. This GUI enables users to view logs, track deployment progress, and access alerts, giving them comprehensive insight into every phase of the deployment lifecycle. Moreover, the system integrates with continuous integration (CI) platforms such as Jenkins or Bamboo, enabling regular code commits, automated testing, and fast feedback loops, which enhance the overall efficiency and reliability of the deployment process. The CI integration ensures that the system can continuously test and refine both the application and infrastructure code, allowing for rapid iterations and improvements.

In addition to CI integration, the command-line interface (CLI) provides flexible access to deployment functions, enabling users to execute deployment commands, access system logs, and perform custom scripts directly. This CLI functionality is ideal for advanced users or for environments where automated scripts drive deployments, offering powerful command-line capabilities for intricate deployment scenarios.

The extensible REST API, also depicted in element 410, facilitates robust interoperability by allowing external systems and tools to interact with the deployment data and configurations. This API layer enables third-party applications to access deployment logs, retrieve configuration details, and update system states as needed, making the system adaptable and interoperable with other enterprise platforms. The API's flexibility promotes seamless data exchange and automates workflows beyond the core system, enabling organizations to extend the automation capabilities of the deployment framework.

Security is rigorously maintained throughout the deployment workflow, underscored by the security component within the release configuration as a code platform, as shown in element 410. This security layer enforces stringent access controls, requiring multifactor authentication (MFA) to access parts of the deployment pipeline. By integrating Lightweight Directory Access Protocol (LDAP) for centralized user authentication and authorization, the system restricts access based on user roles, safeguarding the deployment environment against unauthorized modifications. This layer ensures that sensitive deployment stages, such as infrastructure changes and application rollouts, are accessible only to qualified personnel, maintaining security and compliance across each deployment.

The system's configuration repository and logging functionality, represented by the internal repository within element 410, provides a centralized repository for infrastructure and application configurations. This repository maintains an accurate, up-to-date record of all configurations, deployment artifacts, and related logs, supporting comprehensive audit trails and compliance reporting. Additionally, an external database within the same element stores extensive deployment data for larger-scale environments, enabling persistent data management and extended logging capabilities. This extensive data storage facilitates long-term analysis and compliance checks, making the system suitable for regulated industries where detailed record-keeping is required.

The release configuration as a code platform, labeled as element 412, operates as the core management console for deployment configurations, overseeing the entire process from infrastructure provisioning to application deployment. This platform supports the export of deployment configurations, enabling organizations to retain records of successful deployment templates or replicate deployment setups across multiple environments. By embedding configuration management, export capabilities, and plugin support, this platform represents a scalable, flexible deployment control center. Its modular structure allows for customizations and integrations, adapting the system to evolving operational needs.

Overall, FIG. 4 showcases a highly cohesive and structured workflow, where each stage is automated and interdependent, resulting in an efficient and error-resistant deployment process. From automated code validation, continuous monitoring, security enforcement, and real-time scalability, the system is meticulously designed to operate with minimal manual intervention, ensuring deployments are consistent, secure, and efficient. The extensive integration capabilities depicted—spanning CI platforms, REST APIs, GUI, CLI, and external databases—demonstrate a deployment solution that is flexible, powerful, and capable of meeting the high demands of modern enterprise environments. Through its detailed, layered automation, FIG. 4 highlights a system built to streamline deployment processes, optimize resource utilization, and support a wide range of infrastructure and application management requirements across varied environments.

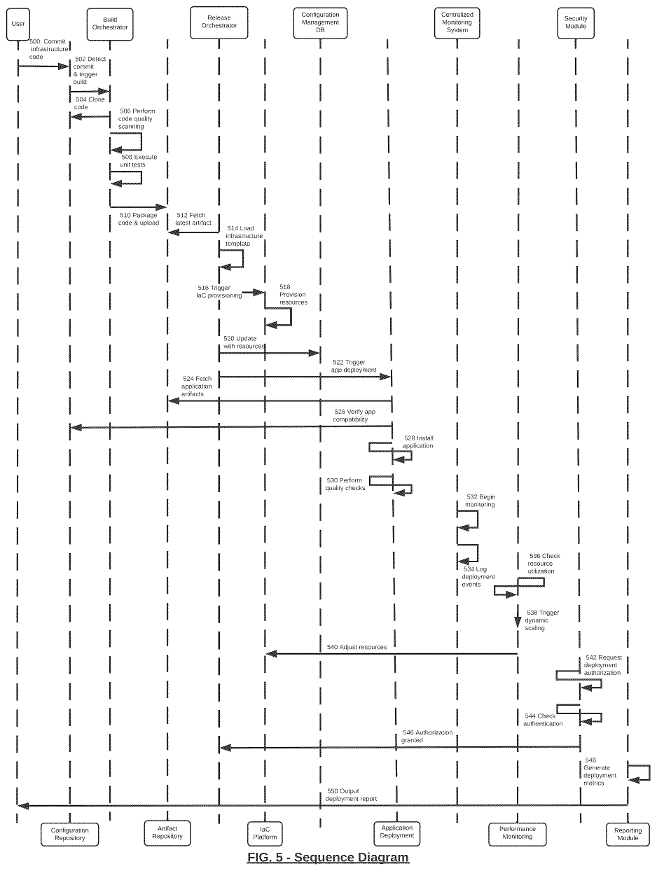

FIG. 5 is a sequence diagram illustrating the hyper-automated deployment process, starting from the initial code commit in the configuration repository and progressing through code validation, infrastructure provisioning, application deployment, monitoring, and reporting. The figure highlights interactions among key components such as the build orchestrator, release orchestrator, IaC platform, and security and monitoring modules to ensure a reliable, secure, and scalable deployment.

In step 500, a user commits infrastructure code to the configuration repository. The user submits the infrastructure as code (IaC) script to the configuration repository to initiate the deployment process.

In step 502, a configuration repository detects a new code commit and triggers the build orchestrator. The repository identifies the new commit and automatically signals the build orchestrator to begin processing the updated infrastructure code.

In step 504, a build orchestrator clones the code from the configuration repository. The orchestrator retrieves the latest IaC code, ensuring that the most recent version is used for validation.

In step 506, the build orchestrator performs code quality scanning. The orchestrator runs a code quality scan to identify any vulnerabilities, inefficiencies, or misconfigurations in the infrastructure code.

In step 508, the build orchestrator executes unit tests on the infrastructure code. Unit tests are performed to validate individual components of the infrastructure configuration, ensuring that they function as expected.

In step 510, the build orchestrator packages validated code and uploads to the artifact repository. After validation, the code is packaged and stored in the artifact repository, providing a secure and versioned source for deployment.

In step 512, a release orchestrator fetches the latest infrastructure artifact from the artifact repository. The release orchestrator retrieves the verified infrastructure artifact to initiate the provisioning process.

In step 514, the release orchestrator loads the infrastructure template for provisioning. This template specifies the resources and configurations needed for the infrastructure, including virtual machines, storage, and network settings.

In step 516, the release orchestrator triggers the infrastructure as code (IaC) platform to provision infrastructure resources. The orchestrator sends the template to the IaC platform, which creates and configures each specified resource.

In step 518, the IaC platform provisions each infrastructure resource based on the template. The platform configures virtual machines, storage, and network components, following the infrastructure specifications outlined in the IaC template.

In step 520, the release orchestrator updates the configuration management database with provisioned resources. After successful provisioning, the orchestrator logs the infrastructure information, such as resource IDs and IP addresses, in the configuration management database.

In step 522, the release orchestrator triggers the application deployment module to retrieve application artifacts from the artifact repository. With the infrastructure in place, the orchestrator signals the application deployment module to prepare the application for deployment.

In step 524, an application deployment module fetches application artifacts from the artifact repository. The module retrieves the necessary files and packages needed for the application to run on the provisioned infrastructure.

In step 526, the application deployment module verifies application compatibility with the infrastructure. Compatibility checks ensure that the application requirements match the available infrastructure resources, such as CPU, memory, and storage.

In step 528, the application deployment module installs the application on the provisioned infrastructure. The module deploys the application components to the infrastructure, applying any necessary configurations to adapt to the environment.

In step 530, the application deployment module performs quality checks on the deployed application. Automated tests are run to verify that the application functions correctly, meeting performance and reliability standards.

In step 532, a centralized monitoring system begins monitoring the deployment status. Once the application is deployed, the monitoring system continuously tracks deployment health, logging events, and detecting any anomalies.

In step 534, the centralized monitoring system logs each deployment event for audit purposes. Each action in the deployment process is logged in real-time, creating an audit trail for compliance and troubleshooting.

In step 536, a performance monitoring system checks resource utilization. The system evaluates infrastructure load and demand, monitoring metrics like CPU and memory usage to assess whether additional resources are needed.

In step 538, the performance monitoring system triggers dynamic scaling if demand exceeds thresholds. When utilization crosses predefined thresholds, the system automatically provisions additional resources to maintain performance.

In step 540, dynamic scaling adds or reduces resources as needed. Based on real-time demand, resources such as virtual machines, storage, or network capacity are scaled up or down to optimize performance and cost efficiency.

In step 542, a security module requests authorization for the deployment approval process. Before continuing to production, the security module enforces an authorization step, requiring verification from designated personnel.

In step 544, the security module checks multifactor authentication and access controls. The system verifies user identity, ensuring that only authorized personnel can approve and manage deployments.

In step 546, authorization granted; deployment proceeds. Upon approval, the system resumes deployment activities, finalizing application setup and production readiness.

In step 548, the reporting module generates detailed deployment metrics. After deployment, the reporting module gathers data on resource utilization, error rates, and deployment times to provide a comprehensive performance summary.

In step 550, the reporting module creates and outputs the deployment report for stakeholders. The report is generated in a structured format, detailing key metrics and insights, supporting data-driven analysis and future optimization.

This sequence of steps provides a structured flow for a fully automated deployment, emphasizing the interactions between each component and the importance of validation, scaling, security, and reporting throughout the deployment lifecycle.

Pseudocode exemplars for implementing various aspects of this disclosure are set forth below with explanations for reference.

In particular, the python pseudocode provided here represents each key aspect of the hyper-automated deployment system, encompassing infrastructure provisioning, application deployment, monitoring, dynamic scaling, security enforcement, and reporting. The pseudocode simulates the entire workflow from the initial infrastructure code commit to the final deployment stages. Each block of pseudocode corresponds to one aspect of the system, illustrating the sequence of actions, dependencies, and validations required to implement this fully automated solution.

```
# Initialize Configuration Repository and Monitor for Changes
initialize_configuration_repository(repo_name,
version_control=“Git”)
monitor_repository(repo_name)
while true:
  if change_detected(repo_name):
    trigger_build_orchestrator( )
    break
# Build Orchestrator Pipeline
def trigger_build_orchestrator( ):
  clone_code(repo_name)
  scan_code_quality(repo_name)
  unit_test(repo_name)
  package_artifacts(repo_name)
  upload_to_artifact_repository(repo_name)
# Release Orchestrator Workflow
def release_orchestrator( ):
  fetch_latest_artifact(repo_name)
  trigger_infrastructure_provisioning( )
  validate_infrastructure( )
# Infrastructure Provisioning with IaC Platform
def trigger_infrastructure_provisioning( ):
  load_infrastructure_template(repo_name)
  for resource in infrastructure_template:
    provision_resource(resource)
  update_configuration_management_db(infrastructure_template)
# Application Deployment on Provisioned Infrastructure
def deploy_application( ):
  fetch_application_artifact(repo_name)
  validate_application_compatibility(infrastructure_template)
  install_application_on_infrastructure( )
  perform_application_quality_checks( )
# Centralized Monitoring and Audit Logging
def monitor_deployment( ):
  while deployment_in_progress:
    log_deployment_status( )
    check_for_anomalies( )
  generate_audit_log( )
# Dynamic Scaling Based on Real-Time Demand
def dynamic_scaling( ):
  while deployment_active:
    if resource_utilization > threshold:
      add_resources( )
    elif resource_utilization < lower_threshold:
      reduce_resources( )
  log_scaling_events( )
# Security Module for Access Control and Approval Process
def enforce_security( ):
  if request_approval( ):
    proceed_with_deployment( )
  else:
    halt_deployment( )
# Reporting Module to Generate Deployment Metrics
def generate_report( ):
  deployment_metrics = fetch_metrics( )
  report = create_report(deployment_metrics)
  output_report(report)
```

As can be seen above, the example pseudocode begins with the initialization of the configuration repository, which is configured to monitor for changes to the infrastructure code. This repository serves as the central source for the IaC scripts and ensures that any updates are automatically detected. The loop continuously monitors the repository, and upon detecting a change in the infrastructure code, it triggers the build orchestrator. This automated monitoring and trigger process eliminates the need for manual intervention, setting the system into motion as soon as the code is modified.

The build orchestrator, as triggered, initiates a series of validation steps, including cloning the code, performing quality scans, running unit tests, packaging validated artifacts, and uploading these to an artifact repository. Each of these functions contributes to ensuring the infrastructure code is secure, compliant, and adheres to organizational standards before proceeding. This validation phase is for minimizing errors in the provisioning stages, as it removes potential risks associated with flawed code configurations. The code quality scans and unit tests provide a thorough check on the infrastructure configurations, further enhancing the robustness of the deployment pipeline.

The release orchestrator is then invoked to coordinate the infrastructure provisioning and application deployment workflows. It fetches the latest artifacts and triggers infrastructure provisioning through the IaC platform. This involves loading an infrastructure template that contains the specifics of each resource required for deployment, such as virtual machines, network configurations, and storage. For each resource specified, the system executes provisioning commands to create and configure the infrastructure according to the defined specifications. Once the resources are established, the configuration management database is updated with the new infrastructure information, ensuring that there is an accurate, real-time record of the deployment status. This comprehensive approach to provisioning ensures consistency and traceability across deployments.

In the application deployment phase, the release orchestrator retrieves the application artifacts and verifies compatibility with the newly provisioned infrastructure. This step is essential for ensuring that the application operates as expected within the configured environment. The system installs the application on the infrastructure, and then a series of quality checks are performed, including functional tests and compatibility checks. These checks confirm that the application meets the required performance and reliability standards, preparing it for production use. The pseudocode demonstrates how each function in the deployment phase contributes to a smooth and error-free rollout of the application.

Once the deployment has commenced, the centralized monitoring module oversees the deployment, logging each step's status and generating real-time alerts in the event of anomalies or errors. This ongoing monitoring enables the system to maintain an accurate record of deployment activities, facilitating quick identification of issues. The module logs each event to an audit log, which provides a detailed history for compliance and troubleshooting purposes. This audit log is essential for maintaining transparency and accountability, particularly in enterprise environments where deployment records are frequently audited.

The system's dynamic scaling module continuously monitors resource utilization in real time. Based on predefined thresholds, it automatically adjusts resource levels by either adding resources if utilization exceeds a certain threshold or reducing them if utilization falls below the lower threshold. This module ensures that infrastructure resources are optimized to meet demand, reducing both costs and performance risks associated with under-or over-provisioned resources. Every scaling event is logged, which further aids in performance analysis and cost management, contributing to an efficient and adaptable infrastructure.

For security and access control, the security module enforces strict protocols, including multifactor authentication and an approval workflow. Before any deployment action occurs, the system requests approval, and only upon authorization does it proceed with the deployment. This layer of control protects sensitive environments and aligns with compliance requirements by ensuring that only authorized personnel can modify or deploy infrastructure and application configurations. If approval is not granted, the deployment is halted, providing an additional safeguard against unauthorized actions.

Finally, the reporting module compiles and generates detailed reports on deployment metrics. After the deployment completes, the module fetches relevant metrics, such as deployment duration, error rates, resource utilization, and application performance. It then creates a comprehensive report, which is output to the stakeholders for review. This report serves as a valuable tool for analyzing deployment efficiency, identifying areas for improvement, and ensuring compliance with operational standards. By automating reporting, the system provides stakeholders with timely insights into deployment performance, enabling data-driven decisions for future optimizations.

This pseudocode sequence collectively demonstrates a fully automated system where infrastructure and application deployments are monitored, validated, scaled, and secured, ensuring reliability, compliance, and efficiency throughout the deployment lifecycle. Each component operates within a tightly orchestrated framework, reflecting a well-integrated and automated approach to modern infrastructure and application management.

A skilled artisan, upon reviewing the disclosure, will appreciate that there are numerous alternatives, modifications, combinations, and customizations that can be made to the systems and methods described herein.

Several alternatives, modifications, combinations, and customizations can be made to the systems and methods described herein, all of which remain within the spirit and scope of the disclosure. These adjustments offer flexibility and adaptability, ensuring the system can cater to various deployment requirements, environments, and organizational needs while maintaining core automation, security, and reliability principles.
a. Alternative Infrastructure Platforms: The infrastructure as code (IaC) platform could be adapted to support additional cloud providers, hybrid setups, or on-premises environments beyond those originally specified. Alternative cloud providers or specialized environments, such as edge computing setups or serverless architectures, could also be integrated, expanding the range of supported infrastructure deployments.
b. Modular Orchestrator Design: The build and release orchestrators could be modularized further, allowing them to be replaced, upgraded, or integrated with third-party orchestration tools based on specific organizational needs. For instance, custom or open-source orchestrators, like Kubernetes-native orchestration for containerized deployments, could be incorporated, enabling more specialized management capabilities.
c. Customizable Approval Workflows: The security module's approval workflow could be adapted to support various organizational approval policies, such as different levels of authorization, custom access permissions, or integration with advanced identity management solutions like OAuth or SAML. The approval workflow could also incorporate role-based access control (RBAC), enabling finer-grained permissions and customized access protocols based on user roles or project requirements.
d. Alternative Monitoring and Logging Solutions: The centralized monitoring and logging system could be replaced or augmented with external monitoring solutions, such as Prometheus, Datadog, or Elastic Stack, to meet different observability needs. This customization could enable more advanced monitoring, tracing, and visualization capabilities, providing deeper insights into system performance, resource utilization, and application health.
e. Flexible Scaling Mechanisms: The dynamic scaling system could be configured to work with various auto-scaling methods, such as predictive scaling, which uses machine learning to anticipate resource needs based on historical data, or spot instance scaling to reduce costs in cloud environments. This customization would provide alternative scaling strategies, optimizing performance and cost-efficiency based on workload patterns.
f. Customizable Configuration Management: The configuration management database could be tailored to support multiple versions, rollback configurations, or integrate with external configuration management tools, such as Ansible, Chef, or Puppet, to enable more complex configuration management needs and support for multi-environment synchronization and drift management.
g. Alternative Continuous Integration and Continuous Deployment (CI/CD) Systems: The system could be configured to work with alternative CI/CD platforms like GitLab CI, CircleCI, or Azure DevOps, providing flexibility in pipeline management and deployment automation. This customization could include specific integrations or plugins for supporting new CI/CD features like parallel testing, artifact caching, or enhanced deployment pipelines.
h. Enhanced Reporting Capabilities: The reporting module could be enhanced to offer customizable reporting templates, integration with business intelligence tools like Tableau or Power BI, or support for real-time dashboards that visualize metrics like deployment speed, error rates, and resource utilization. This enables stakeholders to access more detailed, personalized, and timely insights into deployment performance.
i. Automated Code Reviews and Security Scans: The system could incorporate automated code review tools and advanced security scanning solutions, such as SonarQube or Snyk, to perform in-depth analyses of the infrastructure and application code. This extension could include vulnerability detection, compliance checks, or code quality improvements, enhancing the overall security and reliability of the deployment process.
j. Integration with Existing DevOps Tools: The deployment system could be customized to integrate with a variety of DevOps tools for enhanced functionality, such as Slack or Microsoft Teams for real-time notifications, JIRA for issue tracking, or ServiceNow for incident management. These integrations would streamline communication, enable faster response times, and improve incident handling during deployments.
k. Customized IaC Templates: The IaC templates used in provisioning could be customized to support specific organizational architectures, such as multi-tiered application environments, microservices, or containerized applications. This customization could also support specialized network configurations, security groups, and multi-region failover configurations for added resiliency.
l. Support for Serverless and Microservices Architectures: The system could be modified to support serverless functions (e.g., AWS Lambda, Google Cloud Functions) and microservices architectures. These modifications would cater to modern application architectures, allowing lightweight, event-driven deployment workflows that scale independently based on demand.
m. Enhanced Machine Learning Integration: The machine learning module could be expanded to include more sophisticated algorithms for predictive analysis, anomaly detection, and automated troubleshooting. For example, by analyzing historical performance and error patterns, the machine learning module could offer predictive scaling recommendations, suggest code optimizations, or identify potential failure points before deployment.
n. Policy-Driven Deployment and Compliance: The policy module could be extended to enforce regulatory compliance, such as GDPR or HIPAA, and define custom policies for data handling, resource management, and security protocols. By enforcing these policies, the system ensures that deployments remain compliant with industry standards, supporting organizations in highly regulated industries.
o. Event-Driven Deployments and Webhook Customizations: Webhooks within the system could be customized to trigger deployment actions based on specific events, such as branch merges, pull requests, or completion of tests. This event-driven architecture enables greater flexibility in deployment triggers, aligning the system with DevOps workflows and increasing automation.
p. Customization of the Extensible REST API: The extensible REST API could be modified to allow additional third-party system integrations, such as enterprise resource planning (ERP) systems, custom development tools, or monitoring and analytics platforms. This customization enables data sharing, remote management, and greater integration of the deployment system with an organization's IT ecosystem.
q. Enhanced Audit and Traceability Functions: The system's audit capabilities could be enhanced to include detailed event logs, multi-level auditing features, and integration with audit platforms. This provides a more granular level of detail, making it easier for organizations to track specific actions, access histories, and compliance events throughout the deployment lifecycle.
r. Tailored User Interfaces and Role-Based Dashboards: The web-based GUI could be customized to offer personalized dashboards for different roles within an organization, such as developer, DevOps engineer, or security analyst. This would provide role-based views, allowing each user to focus on the metrics and functions most relevant to their responsibilities, improving overall usability.
s. Multi-Region and Disaster Recovery Configurations: The deployment system could be configured to support multi-region failover and disaster recovery plans, ensuring high availability in case of regional outages. Custom IaC templates and orchestration rules could specify secondary regions and automated failover steps, enhancing resiliency and business continuity.
t. Enhanced Resource Allocation and Cost Management: The system could incorporate resource management policies, enabling organizations to define maximum resource limits or specify cost optimization strategies, such as scheduling downtime for non-essential services or selecting lower-cost resources. By enabling cost controls, the system supports budget management and resource efficiency.
u. User-Customizable Build Orchestrator Pipelines: The build orchestrator could be modified to allow users to define custom pipeline steps, such as additional quality checks, specialized tests, or integration with code quality tools, based on project requirements. This flexibility allows for highly tailored deployment workflows that cater to specific application needs.

These alternatives, modifications, combinations, and customizations ensure the system is adaptable to a wide array of deployment needs, infrastructure environments, and operational requirements. By incorporating these flexible options, the hyper-automated deployment system remains within the spirit and scope of the disclosure, enabling a more versatile, reliable, and efficient deployment process across diverse industry applications and technological landscapes.

Although the present technology has been described based on what is currently considered the most practical and preferred implementations, it is to be understood that this detail is only for that purpose and this disclosure is not limited to the sample descriptions and implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

1. A method for hyper-automating deployment of applications with integrated infrastructure provisioning, comprising:
providing, by a configuration repository, a version-controlled storage of infrastructure as code (IaC) scripts defining infrastructure configurations necessary for application deployment, wherein the IaC scripts specify resources including virtual machines, storage volumes, network settings, and security configurations to meet application operational requirements;
initiating, by a build orchestrator, a continuous integration process upon detection of a change in the infrastructure code, wherein the build orchestrator performs automated syntax validation, logical integrity checks, and other preliminary validations on the infrastructure code;
triggering, by the build orchestrator, a series of automated steps, including code quality scanning to verify adherence to coding standards, unit testing of individual IaC components, packaging of validated scripts, and artifact storage in an artifact repository, with each step logged and version-controlled to enable traceability and rollback in case of deployment errors;
initiating, by a release orchestrator, an IaC platform to execute the provision of infrastructure resources based on the IaC scripts stored in the configuration repository, wherein the IaC platform dynamically generates and configures specified resources in a targeted environment, such as a cloud or on-premises datacenter, ensuring consistency across environments through automated setup procedures;
validating, by the release orchestrator, the provisioned infrastructure by verifying successful execution, including checking resource creation status, compliance with network policies, adherence to security protocols, and resource configuration accuracy, thereby ensuring alignment with predefined security, performance, and compliance requirements;
updating, by the release orchestrator, provisioned infrastructure information in a configuration management database, capturing details such as IP addresses, instance types, allocated resources, and security settings, enabling consistency across deployments, reducing configuration drift, and supporting audit requirements;
deploying, by a tech stack deployment module, essential software dependencies, libraries, and security protocols on the provisioned infrastructure, wherein the tech stack includes core components such as runtime environments, monitoring agents, encryption standards, and authentication mechanisms, ensuring the environment is fully prepared to support a target application;
initiating, by the release orchestrator, an application deployment workflow by triggering an application deployment module to retrieve application artifacts from the artifact repository and to install and configure these artifacts within the provisioned infrastructure according to application-specific requirements and dependencies;
conducting, by the application deployment module, automated application quality checks and performance validation, including load testing, functional verification, and security vulnerability scans, to confirm that the application operates reliably and meets performance criteria within the provisioned infrastructure;
dynamically scaling, by the release orchestrator, provisioned infrastructure resources based on real-time application demand by adding or reducing resources such as virtual machines, storage capacity, or network bandwidth as needed, wherein scaling decisions are informed by metrics from a performance monitoring system and occur automatically based on predefined thresholds for resource utilization;
logging, by a centralized monitoring system, each step of a deployment process, including infrastructure provisioning, application deployment, scaling events, security checks, and configuration changes, to maintain a comprehensive audit trail, enable real-time monitoring of deployment activities, and facilitate troubleshooting by tracking deployment history and performance data;
enforcing, by a security module integrated within the release orchestrator, an approval process requiring authorization from designated personnel, such as security administrators or compliance officers, before deploying or scaling infrastructure and applications in production environments, ensuring that all deployment activities meet organizational and regulatory standards; and
providing, by a reporting module, a detailed deployment summary that includes metrics on resource configurations, application versions, deployment durations, error rates, and resource utilization, wherein the report is accessible through a user interface for stakeholders, enabling continuous improvement of the deployment process, enhanced visibility, and adherence to compliance standards.

2. The method of claim 1, wherein the configuration repository is configured to support version control systems selected from the group consisting of Git, Subversion, Mercurial, and other distributed or centralized version control systems, enabling collaborative management and history tracking of IaC scripts.

3. The method of claim 2, wherein the build orchestrator performs additional automated steps including static code analysis to detect vulnerabilities or inefficiencies in the infrastructure.

4. The method of claim 3, wherein the code quality scanning includes identifying code patterns that could lead to misconfigurations or security risks, including incorrect permissions, improper network configurations, and unoptimized resource allocation.

5. The method of claim 4, wherein the unit testing of IaC components simulates infrastructure creation in a controlled test environment, verifying the functionality and compatibility of each infrastructure component prior to deployment in a production environment.

6. The method of claim 5, wherein the artifact repository is configured to store and manage multiple versions of the validated scripts, enabling rollback to previous versions in case of deployment issues.

7. The method of claim 6, wherein the IaC platform executes infrastructure provisioning by interfacing with cloud provider APIs, including but not limited to AWS, Azure, and Google Cloud Platform, to dynamically create and configure resources in cloud environments.

8. The method of claim 7, wherein the IaC platform includes a capability to provision hybrid infrastructure environments, integrating both on-premises data centers and cloud resources to meet specific deployment requirements.

9. The method of claim 8, wherein the release orchestrator performs post-provisioning compliance checks by cross-referencing the infrastructure configuration with predefined security policies, including network access control and encryption standards.

10. The method of claim 9, wherein the configuration management database includes metadata for each provisioned resource, such as creation timestamps, version identifiers, and dependency relationships, facilitating resource lifecycle management.

11. The method of claim 10, wherein the tech stack deployment module is pre-configured with libraries and toolsets that support containerized environments, such as Docker and Kubernetes, allowing deployment of applications in containerized or microservices architectures.

12. The method of claim 11, wherein the application deployment module is configured to retrieve application-specific configuration files from the artifact repository, ensuring that application settings are dynamically adjusted based on the deployment environment.

13. The method of claim 12, wherein the application deployment module includes a rollback feature that automatically reverts to a previous stable version of the application in the event of a deployment failure.

14. The method of claim 13, wherein the performance validation conducted by the application deployment module includes stress testing the application to evaluate its response under high load conditions, ensuring scalability and reliability.

15. The method of claim 14, wherein the centralized monitoring system generates real-time alerts for any deployment anomalies, such as failed infrastructure provisioning or performance bottlenecks, enabling proactive troubleshooting.

16. The method of claim 15, wherein the security module integrated within the release orchestrator supports multifactor authentication for accessing the approval process, enhancing security in production environments.

17. The method of claim 16, wherein the reporting module provides customizable reports that detail deployment metrics, error trends, and resource utilization forecasts, supporting data-driven decision-making for future deployments.

18. A system for hyper-automating deployment of applications with integrated infrastructure provisioning, comprising:
a configuration repository, configured to store and manage infrastructure as code (IaC) scripts in a version-controlled environment, wherein the repository enables consistent infrastructure configurations by tracking modifications to scripts that define resources, network settings, security policies, and other deployment parameters;
a build orchestrator, in communication with the configuration repository, configured to detect changes in IaC scripts and initiate a continuous integration pipeline, wherein the build orchestrator automatically performs syntax validation, logical integrity checks, code quality scans, unit testing, and artifact packaging, ensuring that infrastructure code is verified for compliance with organizational standards prior to deployment;
an artifact repository, connected to the build orchestrator, configured to store validated IaC artifacts, wherein the artifact repository retains multiple versions of each artifact, enabling rollback and traceability in case of deployment issues;
a release orchestrator, in communication with the configuration repository and the artifact repository, configured to coordinate both infrastructure provisioning and application deployment workflows, wherein the release orchestrator initiates an IaC platform to provision infrastructure resources based on validated IaC scripts and ensures deployment compliance with security and configuration standards by enforcing an order of operations and dependency checks;
an IaC platform, coupled with the release orchestrator, configured to interact with cloud provider APIs, hybrid environments, or on-premises infrastructure to create and configure resources, including virtual machines, storage, and network components, according to specifications in the IaC scripts, wherein the IaC platform enables consistent infrastructure deployment across multiple environments;
a configuration management database, in communication with the release orchestrator, configured to store and manage information about provisioned infrastructure resources, including resource identifiers, configurations, dependencies, and versioning details, ensuring that the system maintains an accurate inventory of current infrastructure states and supports audit requirements;
a tech stack deployment module, connected to the release orchestrator, configured to deploy essential software dependencies, libraries, runtime environments, and security protocols on the provisioned infrastructure, preparing the environment to support application functionality by ensuring necessary software prerequisites are in place;
an application deployment module, in communication with the release orchestrator and the artifact repository, configured to retrieve application artifacts, install them on the provisioned infrastructure, and apply environment-specific configurations, wherein the application deployment module ensures that applications are correctly deployed with respect to both infrastructure and application dependencies;
a centralized monitoring system, in communication with the release orchestrator, configured to log each step of a deployment process, including infrastructure provisioning, application deployment, scaling events, and security checks, providing real-time monitoring and maintaining a comprehensive audit trail to support troubleshooting and compliance tracking;
a performance monitoring system, coupled with the release orchestrator, configured to track resource utilization and application performance, wherein the performance monitoring system provides metrics used by the release orchestrator to dynamically scale infrastructure resources based on predefined thresholds, automatically adjusting virtual machines, storage, and network capacities in response to application demand;
a security module, integrated with the release orchestrator, configured to enforce access controls and initiate an approval workflow requiring authorization from designated personnel before deploying or scaling infrastructure in production environments, ensuring that all deployment activities align with security policies and regulatory standards; and
a reporting module, in communication with the release orchestrator and the centralized monitoring system, configured to generate detailed reports on deployment metrics, error rates, resource utilization, and historical deployment data, wherein the reporting module supports data-driven decision-making by providing stakeholders with insights into deployment efficiency, resource allocation, and potential areas for optimization.

19. The system of claim 18, wherein the build orchestrator further comprises a machine learning module configured to analyze historical deployment data, infrastructure configurations, and code quality metrics stored in the artifact repository and configuration management database, wherein the machine learning module performs:
pattern recognition to identify common causes of deployment errors by analyzing error logs, build failures, and rollback events, allowing it to recommend adjustments to IaC scripts, such as optimizing network configurations, adjusting resource allocations, or modifying security settings, to prevent similar issues in future deployments;
trend analysis on code quality metrics across multiple deployments, wherein the machine learning module detects trends in issues such as misconfigurations, inefficient resource usage, or security vulnerabilities, providing insights and suggesting modifications to improve robustness, performance, and compliance of infrastructure configurations over time;
predictive failure analysis by evaluating real-time data against historical deployment trends, wherein the module identifies and flags potential failure points in a deployment pipeline before they occur, triggering alerts or automated mitigations in the build orchestrator to reduce a likelihood of disruptions in production environments; and
adaptive learning from user feedback on recommended adjustments and deployment outcomes, wherein the module refines its prediction models and recommendation algorithms based on success of previous deployments, continuously improving its accuracy and effectiveness in optimizing infrastructure code quality and deployment reliability.

20. A method for hyper-automating deployment of applications with integrated infrastructure provisioning, comprising:
storing, by a configuration repository, infrastructure as code (IaC) scripts that define infrastructure configurations, wherein the IaC scripts are version-controlled and specify resources, network policies, security settings, and dependencies needed for a deployment environment;
initiating, by a build orchestrator, a continuous integration pipeline in response to changes detected in the IaC scripts, wherein the build orchestrator automatically performs syntax validation, code quality scans, unit testing, and packaging of the IaC scripts, ensuring the scripts meet organizational and technical standards for deployment;
storing, by an artifact repository, validated versions of IaC scripts from the build orchestrator, wherein the artifact repository maintains multiple versions to allow rollback and traceability for each deployment;
triggering, by a release orchestrator, an IaC platform to provision infrastructure resources as defined in the IaC scripts, wherein the IaC platform interfaces with cloud provider APIs, hybrid environments, or on-premises data centers to create virtual machines, network configurations, storage, and security settings specified in the IaC scripts;
verifying, by the release orchestrator, that provisioned infrastructure meets predefined requirements for security, compliance, and configuration accuracy by cross-referencing created resources with internal policies and standards, thereby ensuring infrastructure reliability and adherence to operational criteria;
updating, by the release orchestrator, a configuration management database with information on provisioned infrastructure resources, including resource identifiers, IP addresses, version data, and configuration details, enabling traceability and auditability of infrastructure states;
installing, by a tech stack deployment module, essential software dependencies and runtime environments on the provisioned infrastructure, wherein the tech stack includes prerequisites such as libraries, monitoring tools, and security protocols that are necessary for application functionality;
deploying, by an application deployment module, application artifacts onto the provisioned infrastructure, wherein the application deployment module retrieves the artifacts from the artifact repository, applies environment-specific configurations, and performs automated checks to verify application integrity and compatibility with the infrastructure;
monitoring, by a centralized monitoring system, each step of a deployment process, including infrastructure provisioning, tech stack installation, and application deployment, to generate an audit trail and provide real-time insights into deployment progress and status;
scaling, by a performance monitoring system in conjunction with the release orchestrator, the provisioned infrastructure dynamically based on real-time demand by adjusting virtual machines, storage, or network bandwidth, wherein scaling decisions are informed by predefined utilization thresholds and performance metrics tracked by the performance monitoring system;
enforcing, by a security module integrated with the release orchestrator, an approval workflow that requires authorization from designated personnel before executing deployments or scaling actions in production environments, ensuring that all activities comply with security protocols and organizational policies; and
generating, by a reporting module, detailed deployment reports that include metrics on resource configurations, error rates, deployment times, and resource utilization, wherein these reports are accessible through a user interface, allowing stakeholders to review, analyze, and improve deployment efficiency and performance based on historical data.
